(19) United States
(12) Patent Application Publication
(10) Pub. No.: US 2009/0020593 A1
(43) Pub. Date: Jan. 22, 2009

(54) Method and Apparatus for Manufacturing Solder Mounting Structure

(75) Inventors: Kazuo Kinoshita, Fukuyama-shi Hiroshima (JP); Katsuitsu Nishida, Soraku-gun Kyoto (JP)

Correspondence Address: EDWARDS ANGELL PALMER & DODGE LLP, P.O. BOX 55874, BOSTON, MA, 02205, US

(73) Assignee: SHARP KABUSHIKI KAISHA, OSAKA (JP)

(21) Appl. No.: 12/224,296

(22) PCT Filed: Jan. 12, 2007
(86) PCT No.: PCT/JP2007/050331

§ 371 Date: Aug. 22, 2008

(30) Foreign Application Priority Data
Feb. 23, 2006 (JP) 2006-047209

(51) Int. Cl. B23K 31/02; B23K 1/012

(52) U.S. Cl. 228/232; 228/234.1; 228/46

(57) ABSTRACT

In manufacturing a camera module structure (100), a hot air nozzle (4) melts solder at a solder connection portion (3) by blowing hot air to the solder connection portion (3), while a suction nozzle (5) suctions the hot air that moves toward the camera module (2), from a position nearer from the camera module (2) than a position of the hot air nozzle (4). This makes it possible to manufacture a solder mounting structure in which a heat-vulnerable electronic component can be mounted on a wiring board without being damaged by heat.

### TECHNICAL FIELD

The present invention particularly relates to: a method for manufacturing a solder mounting structure in which a heat-vulnerable electronic component is mounted on a wiring board without being damaged by heat; and an apparatus for manufacturing the solder mounting structure.

### BACKGROUND ART

For the purpose of mounting electronic components (such as an integrated circuit (an IC), a resistor, a capacitor, and the like) on a printed circuit board by a soldering, a soldering that employs a reflow apparatus or a flow solder bath has been carried out. Particularly, the reflow apparatus has been often used recently.

The reflow apparatus carries out the soldering by putting, into a reflow furnace thereof, a printed circuit board mounted with electronic components (see Patent Document 1, for example). This allows the reflow apparatus to be useful for flexibly dealing with, for example, a soldering with respect to a printed circuit board that has a complicated shape.

On the other hand, a spot soldering for locally heating only a soldering portion (a solder connection portion) has been proposed as another soldering method (see Patent Document 2, for example). This spot soldering uses hot air for heating the soldering portion.

Further, Patent Document 3 discloses a soldering method for preventing an electronic circuit (an electronic component) from being heated. FIG. 21 is a view illustrating an apparatus for the soldering method of Patent Document 3. With this method, after the soldering, the hot air is suctioned away from a soldering portion 103 oppositely from an electronic circuit 102 (i.e., externally with respect to the soldering portion 103). In short, a suction nozzle 105 suctions the hot air blown from a hot air nozzle 104.

These soldering methods have a big advantage in self-alignment. The self-alignment is a technique for aligning the printed circuit board and the electronic components by making use of a surface tension and a viscosity of melted solder. The self-alignment is often used in a soldering technique for mounting the electronic components on a surface.

### (Patent Document 1)

Japanese Unexamined Patent Publication No. 2004-235381 (Tokukai 2004-235381) (published on Aug. 19, 2004)

### (Patent Document 2)

Japanese Unexamined Patent Publication No. 2005-79124 (Tokukai 2005-79124) (published on Mar. 24, 2005)

### (Patent Document 3)

Japanese Unexamined Patent Publication No. 151032/1994 (Tokukaihei 6-151032) (published on May 31, 1994)

### DISCLOSURE OF INVENTION

However, the conventional methods are unsuitable for mounting a heat-vulnerable (low-heat-resistance) electronic component.

Specifically, in the soldering employing the reflow apparatus, the electronic components are put into the reflow furnace. That is, the electronic components are also heated. For this reason, the soldering employing the reflow apparatus is unsuitable for mounting the heat-vulnerable electronic component (such as a camera module).

Further, in the spot soldering, although provided locally, the hot air flows off outside the soldering portion. This causes the hot air to also heat the electronic components that are to be mounted on the printed circuit board. For this reason, the spot soldering is unsuitable for mounting the heat-vulnerable electronic component, as well as the soldering employing the reflow apparatus.

With the arrangement illustrated in FIG. 21, from the opposite position of the electronic circuit 102 (i.e., externally with respect to the soldering portion 103), the suction nozzle 105 suctions the hot air. Moreover, with the arrangement, the hot air nozzle 104 blows the hot air perpendicularly to the soldering portion 103. Thereby, although the hot air is suctioned, it is impossible to prevent flow-off of the hot air toward the electronic circuit 102. As a result, the flow-off hot air heats the electronic circuit 102. Thus, this arrangement is unsuitable for mounting the heat-vulnerable electronic component, too.

Patent Document 3 also discloses another arrangement with which cold air blows to the soldering portion 103. FIG. 22 is a view illustrating the arrangement. In the arrangement, a cold air nozzle 106 is provided on an electronic circuit 102 side. In the arrangement, the hot air nozzle 104 blows the hot air to the soldering portion 103, while the suction nozzle 105 suctions the hot air, and the cold air blows to the soldering portion 103.

As described above, with the arrangement illustrated in FIG. 21, the flow-off of the hot air to the electronic circuit 102 cannot be prevented. In order to prevent such flow-off of the hot air, the arrangement of Patent Document 3 should be an arrangement as illustrated in FIG. 22, that is to say, the arrangement having the cold air nozzle 106 in addition to the hot air nozzle 104 and the suction nozzle 105.

However, this arrangement requires the cold air nozzle 106 to be positioned between the soldering portion 103 and the electronic circuit 102. As a result, due to a short distance between the electronic circuit 102 and the soldering portion 103, a collision between the electronic circuit 102 and the cold air nozzle 106 is caused. That is, it becomes impossible to allow the cold air nozzle 106 to have such a position depending on a mounting position or a size of the electronic circuit 102. Thus, the mounting position or size of the electronic circuit 102 greatly limits the use of three nozzles.

The present invention is made in view of the above problems. An object of the present invention is to provide: a method for manufacturing a solder mounting structure in which a heat-vulnerable electronic component is solder-mounted on a wiring board without being damaged by heat; and an apparatus for manufacturing the solder mounting structure.

In view of the problems described above, a method according to the present invention, for manufacturing a solder mounting structure includes mounting an electronic component on a wiring board via a solder connection portion, wherein, in the step of mounting, a blow of hot air melts solder at the solder connection portion, while the hot air moving toward the electronic component is suctioned from a position nearer from the electronic component than a hot air blowing position.

With the method, the hot air moving toward the electronic component is suctioned from the position nearer from the electronic component than the hot air blowing position. This makes it possible that even if the blow of the hot air causes flow-off of the hot air toward the electronic component, the flow-off hot air is successfully suctioned. Thereby, it is possible to prevent the electronic component from being heated by the hot air. Thus, the electronic components can be mounted on a substrate without a heat-vulnerable electronic component being damaged by heat.

In view of the problems described above, a method according to the present invention, for manufacturing a solder mounting structure includes mounting an electronic component on a wiring board via a solder connection portion, wherein, in the step of mounting, a blow of hot air melts solder at the solder connection portion, while the hot air moving toward the electronic component and atmosphere in a vicinity of the electronic component are suctioned together from a position nearer from the electronic component than a hot air blowing position.

With the method, the hot air moving toward the electronic component is suctioned from the position nearer from the electronic component than the hot air blowing position, so that it becomes possible that even if the hot air flows off toward the electronic component, the flow-off hot air is successfully suctioned. Thereby, it is possible to prevent the electronic component from being heated by the hot air. Thus, the electronic components can be mounted on the substrate without the heat-vulnerable electronic component being damaged by heat.

In view of the problems described above, an apparatus according to the present invention, for manufacturing a solder mounting structure in which an electronic component is mounted on a wiring board via a solder connection portion, includes a hot air nozzle configured to blow hot air to the solder connection portion, and a suction nozzle configured to suction at least part of the hot air, the hot air nozzle melting solder at the solder connection portion by blowing the hot air while the suction nozzle suctions the hot air moving toward the electronic component, from a position nearer from the electronic component than a position of the hot air nozzle.

With the arrangement, from the position nearer from the electronic component than the hot air blowing position of the hot air nozzle, the suction nozzle suctions the hot air moving toward the electronic component. This makes it possible that even if the blow of the hot air causes the flow-off of the hot air toward the electronic component, the flow-off hot air is successfully suctioned. Thereby, it is possible to prevent the electronic component from being heated by the hot air. Thus, the electronic components can be mounted on a substrate without the heat-vulnerable electronic component being damaged by heat.

In view of the problems described above, an apparatus according to the present invention, for manufacturing a solder mounting structure in which an electronic component is mounted on a wiring board via the solder connection portion, includes a hot air nozzle configured to blow hot air to the solder connection portion, and a suction nozzle configured to suction the hot air, the hot air nozzle melting solder at the solder connection portion by blowing the hot air, while the suction nozzle, from a position nearer from the electronic component than a position of the hot air nozzle, suctioning: the hot air moving toward the electronic component; and atmosphere in the vicinity of the electronic component.

With this arrangement, from the position nearer from the electronic component than the hot air blowing position of the hot air nozzle, the suction nozzle suctions the hot air moving toward the electronic component. This makes it possible that even if the blow of the hot air causes the flow-off of the hot air toward the electronic component, the flow-off hot air is successfully suctioned. Thereby, it is possible to prevent the electronic component from being heated by the hot air. Thus, the electronic component can be mounted on the substrate without the heat-vulnerable electronic component being damaged by heat.

Moreover, with the above arrangement, from the position nearer from the electronic component than the position of the hot air nozzle, atmosphere (open air) in the vicinity of the electronic component is suctioned in addition to the hot air, so that the suctioned open air can cool melted solder. This results in an improvement in cooling efficiency of the melted solder.

For a fuller understanding of the nature and advantages of the invention, reference should be made to the ensuing detailed description taken in conjunction with the accompanying drawings.

### BRIEF DESCRIPTION OF DRAWINGS

FIG. 1 is a view illustrating a flow of air in the vicinity of a hot air nozzle and a suction nozzle in a solder mounting step that employs an apparatus according to the present invention, for manufacturing a camera module structure.

FIG. 2 is a block diagram schematically illustrating the apparatus according to the present invention, for manufacturing the camera module structure.

FIG. 3 is a perspective view illustrating a nozzle head of the manufacturing apparatus of FIG. 2.

FIG. 4 is a top view illustrating a solder mounting step that employs the apparatus according to the present invention, for manufacturing the camera module structure.

FIG. 5(a) is a view illustrating a method for forming a solder connection portion.

FIG. 5(b) is another view illustrating the method for forming the solder connection portion.

FIG. 6 is a cross-sectional view illustrating a step in a method according to the present invention, for manufacturing the camera module structure.

FIG. 7 is a cross-sectional view illustrating the following step of FIG. 6, for manufacturing the camera module structure.

FIG. 8 is a cross-sectional view illustrating the following step of FIG. 7, for manufacturing the camera module structure.

FIG. 9 is a cross-sectional view illustrating the following step of FIG. 8, for manufacturing the camera module structure.

FIG. 10 is a view illustrating a primary position of the nozzle head in a step in the method according to the present invention, for manufacturing the camera module structure.

FIG. 11 is a view illustrating a position of the nozzle head in the solder mounting step in the method according to the present invention, for manufacturing the camera module structure.

FIG. 12 is a view illustrating the camera module structure manufactured according to the present invention.

FIG. 13 is a view illustrating a printed circuit board and a camera module in the camera module structure of FIG. 12.

FIG. 14 is a temperature profile in the solder mounting step in the method according to the present invention, for manufacturing the camera module structure.

FIG. 15 is a view illustrating a printed circuit board and a camera module, both of which differ from those of FIG. 13.

FIG. 16 is a block diagram schematically illustrating another apparatus according to the present invention, for manufacturing the camera module structure.

FIG. 17 is a top view of the manufacturing apparatus of FIG. 16.

FIG. 18 is a cross-sectional view illustrating the step for manufacturing the camera module structure by the manufacturing apparatus of FIG. 16.

FIG. 19 is a cross-sectional view illustrating the following step of FIG. 18, for manufacturing the camera module structure.

FIG. 20 is a cross-sectional view illustrating the following step of FIG. 19, for manufacturing the camera module structure.

FIG. 21 is a view schematically illustrating a soldering apparatus of Patent Document 3.

FIG. 22 is a view schematically illustrating another soldering apparatus of Patent Document 3.

### EXPRESSION OF REFERENCE LETTERS

1. PRINTED CIRCUIT BOARD (SUBSTRATE)
2. CAMERA MODULE (ELECTRONIC COMPONENT)
3. SOLDER CONNECTION PORTION
4. HOT AIR NOZZLE
5. SUCTION NOZZLE
100. CAMERA MODULE STRUCTURE (SOLDER MOUNTING STRUCTURE)

### BEST MODE FOR CARRYING OUT THE INVENTION

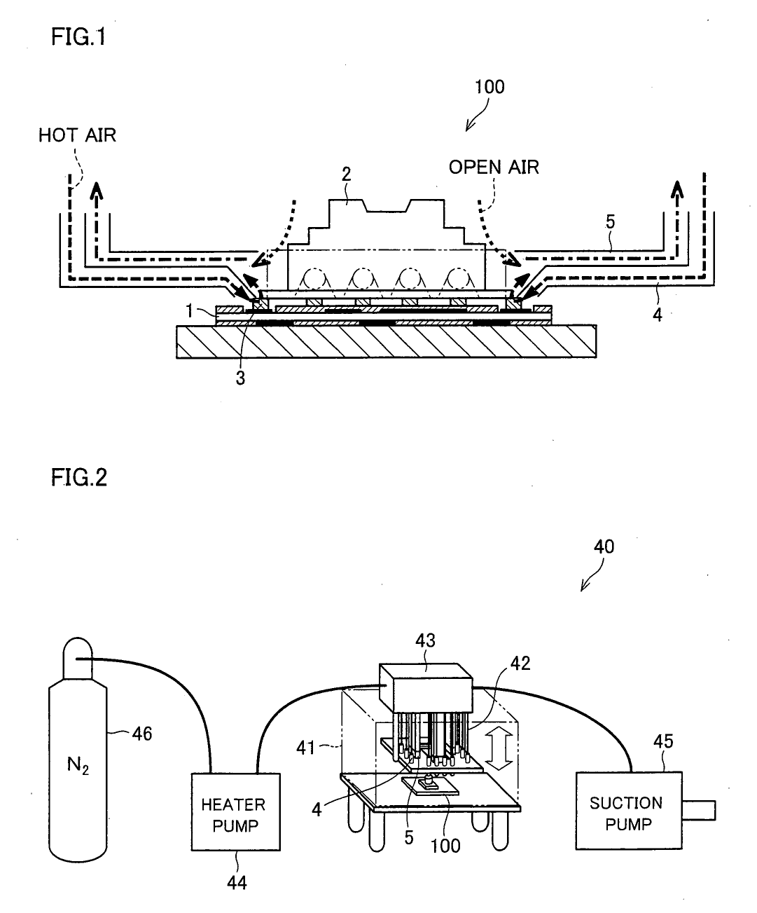

One embodiment of the present invention is described below with reference to the attached FIGS. 1 to 20. Note that the present invention is not limited to this.

### EMBODIMENT 1

The present invention is for preventing hot air from flowing toward an electronic component in manufacturing a solder mounting structure in which the electronic component is mounted on a substrate via a solder connection portion. Accordingly, the present invention is particularly useful for mounting a heat-vulnerable electronic component on a substrate.

First, the solder mounting structure manufactured according to the present invention is described below.

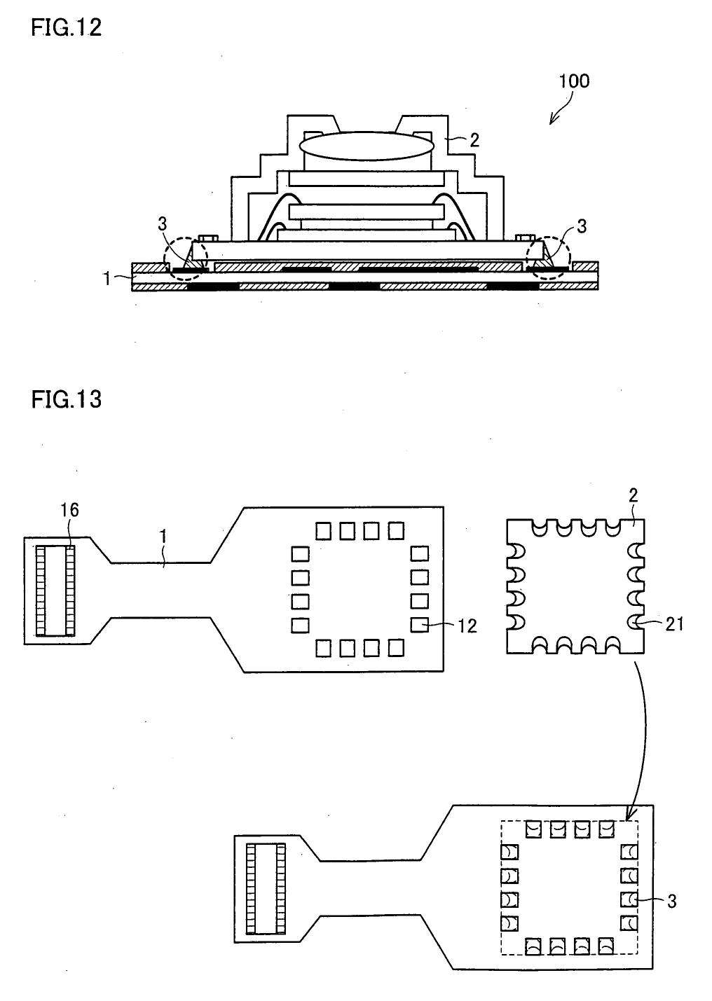

In the present embodiment, a camera module structure (the solder mounting structure) included in electronics such as a mobile phone or a digital still camera is explained. FIG. 12 is a cross-sectional view partially illustrating a camera module structure 100 of the present embodiment.

The camera module structure (the solder mounting structure) 100 of the present embodiment is arranged so that a solder connection portion (a solder pad) 3 connects a printed circuit board (a substrate) 1 with a camera module (i.e. an electronic component, or an optical component) 2. In the explanation, of the printed circuit board 1 of the camera module 100, hereinafter, a surface that is mounted with the camera module 2 is referred to as a “front surface”, and the opposite surface is referred to as a “back surface”.

FIG. 13 is a plan view illustrating the front surface of the printed circuit board 1 and the back surface of the camera module 2.

The printed circuit board 1 is a sheet substrate as illustrated in FIGS. 12 and 13. The printed circuit board 1 may be a flexible printed circuit board (an FPC board), for example. The printed circuit board 1 is not limited in sort or material.

On the front surface (a mounted surface) of the printed circuit board 1, a plurality of terminals 12, a wiring pattern (not illustrated), and a connector 16 are formed.

A plurality of the terminals 12 is formed in a region where the camera module 2 is to be mounted. In the present embodiment, the terminals 12 are positioned in a quadrangular formation (in four different directions). The terminal 12 may be made of a metal such as copper foil that is plated with gold, for example. As illustrated in FIG. 13, the solder connection portion 3 is formed on the terminal 12 so that the camera module 2 is connected with the terminal 12 by a soldering. Further, the terminal 12 touches the wiring pattern, so that the printed circuit board 1 and the camera module 2 are conducted via the solder connection portion 3.

The connector 16 is for electrically connecting the camera module structure 100 with other components. The connector 16 is formed outside a region where the camera module 2 is to be mounted. The connector 16 sends, for example, an image data that recorded by the camera module 2 to other components. That is to say, the printed circuit board 1 also functions as a relay board.

The camera module 2 is a lens member (an optical component) that is included in a mobile phone, a digital still camera, or the like. The camera module 2 usually includes, on a substrate, various elements such as a lens, an IR-cut filter, a CCD/CMOS sensor, a signal processing IC, a resistor, a capacitor, and the like. Each of these elements is covered with a resin housing. The housing is connected to the substrate by adhesive resin. A soldering portion at a lower part of the camera module is made of a relatively-heat-stable material.

As illustrated in FIG. 13, on the back surface (a bottom surface) of the camera module 2, a plurality of terminals 21 corresponding to the terminals 12 of the printed circuit board 1 are formed. The terminal 12 formed on the printed circuit board 1 and the terminal 21 formed on the camera module 2 are positioned to face each other, and the printed circuit board 1 and the camera module 2 are connected with each other by the solder connecting portion 3 formed between the terminal 12 and the terminal 21. Thereby, an electrical signal of the camera module 2 is sent to the printed circuit board 1 via the solder connection portion 3. That is, the electrical signals of both the printed circuit board 1 and the camera module 2 are communicated between them via the solder connection portion 3. A portion (the soldering portion) of the back surface of the camera module 2, to which portion the terminal 21 is formed, is made of a relatively-heat-stable material.

As such, the camera module structure 100 is arranged such that the camera module 2 is connected to the surface of the printed circuit board 1 via the solder connection portion 3.

Next, the following explains an apparatus and a method, for manufacturing the camera module structure 100.

Optical components included in the camera module 2, such as the lens, the IR-cut filter, the CCD/CMOS sensor, and the like, are heat-vulnerable components. Particularly, the lens (made of glass or resin) that is necessary for maintenance of required optical characteristics has a low upper temperature limit of approximately 80° C. For this reason, when the camera module 2 is heated, the optical components are damaged by heat.

The apparatus and the method of the present embodiment, for manufacturing the camera module structure 100, are arranged so that solder at the solder connection portion is melted by a blow of hot air, while the hot air that moves toward the camera module 2 is suctioned. This causes suction of excess hot air that does not contribute to the melting of solder, especially the hot air that moves toward the camera module 2. Accordingly, the camera module 2 can be mounted on the printed circuit board 1 without being damaged by heat.

The following specifically explains the apparatus and the method for manufacturing the camera module structure 100.

FIG. 2 is a view schematically illustrating a main part of an apparatus 40 for manufacturing the camera module structure 100. As illustrated in FIG. 2, the manufacturing apparatus 40 of the present embodiment carries out a solder mounting of the camera module structure 100 (mounting the camera module 2 on the printed circuit board 1), which is carried into a process room 41. In the present embodiment, the camera module structure 100 that is carried into the process room 41 is solder-mounted one by one.

The manufacturing apparatus 40 carried out the solder mounting step by using a nozzle head 42 provided in the process room 41. The nozzle head 42 is connected with an elevating machine 43 so that the nozzle head 42 can move up and down thereby adjusting its height.

The nozzle head 42 includes a hot air nozzle 4 and a suction nozzle 5. The nozzle head 42 is connected with a heater pump 44 for the hot air nozzle 4, and a suction pump 45 for the suction nozzle 5.

The heater pump 44 is configured to adjust a flow amount of the hot air exhausted from the hot air nozzle. The heater pump 44 is connected with a cylinder 46. Gas in the cylinder 46 is heated by the heater pump 44, and exhausted from the hot air nozzle 4.

Gas in the cylinder 46 may be inactive gas (a first inactive gas) such as nitrogen, for example. The inactive gas is not limited to nitrogen as long as the gas can prevent oxidation of solder. Meanwhile, it is preferable to fill also the process room 41 with inactive gas (a second inactive gas). That is, it is preferable to carry out the solder mounting step under an atmosphere of the inactive gas. This prevents oxidation of solder. In consideration of availability, safety, and costs, nitrogen is preferably used as these inactive gases.

The suction pump 45 is configured to adjust a suction amount of the suction nozzle 5.

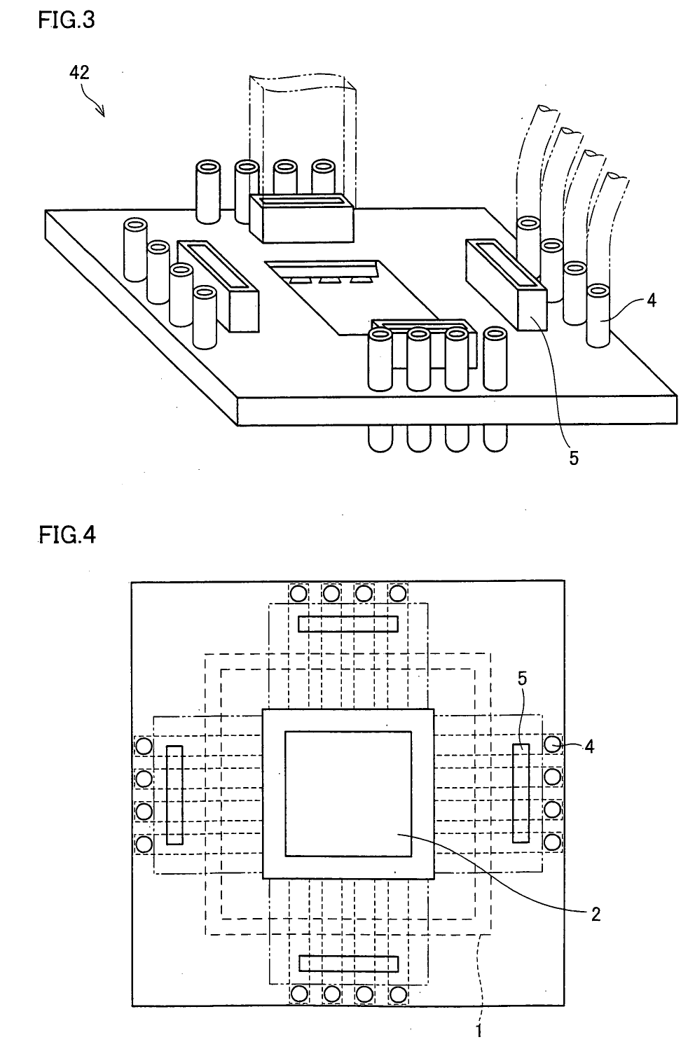

FIG. 3 is a perspective view (a schematic view) of the nozzle head 42. The nozzle head 42 includes the hot air nozzle 4 and the suction nozzle 5. A blowing orifice of the hot air nozzle 4 and a suction orifice of the suction nozzle 5 are separated from each other. In the present embodiment, the hot air nozzle 4 and the suction nozzle 5 are formed integrally. Further, in the present embodiment, the hot air nozzle 4 and the suction nozzle 5 are provided close to each other. Furthermore, in the present embodiment, an end (a hot-air-blowing orifice) of the hot air nozzle 4 and an end (a hot-air-suction orifice) of the suction nozzle 5 are movable so that it is possible to adjust angles of a blow or a suction of the hot air. The end of the hot air nozzle 4 is widened so that the hot air easily spreads.

The hot air nozzle 4 melts solder by blowing the hot air to the solder connection portion 3 in the solder mounting. This hot air is heated gas (nitrogen gas in the present embodiment) in the cylinder 46. In the present embodiment, the end (the orifice of the nozzle) of the hot air nozzle 4 is movable so as to blow the hot air to the solder connection portion 3 in an oblique direction from an opposite side (outside) of the camera module 2.

As described above, in the present embodiment, a plurality of the solder connection portions 3 is formed so as to respectively correspond to a plurality of the terminals 12 formed on the printed circuit board 1 (see FIG. 13). A plurality of the hot air nozzles 4 is provided so as to blow the hot air to each of the solder connection portions 3. That is, in the present embodiment, the hot air blows to each of a plurality of the solder connection portions 3 independently.

It is possible to provide the hot air nozzles 4 not to correspond to each of the solder connection portions 3 independently. For example, one hot air nozzle 4 may blow the hot air to a plurality of the solder connection portions 3.

On the other hand, the suction nozzle 5 suctions part of the hot air blown from the hot air nozzle 4, i.e., excess hot air that does not contribute to the melting of solder at the solder connection portion 3. In the present embodiment, one suction nozzle 5 is arranged to suction the hot air from a plurality of the hot air nozzles 4. More specifically, in the present embodiment, a plurality of the hot air nozzles 4 is positioned in a quadrangular formation. At each side of the quadrangle, four hot air nozzles 4 are positioned. At each of the sides, one suction nozzle 5 is provided, and is arranged to suction the hot air from four hot air nozzles 4.

In the present embodiment, the orifice (the hot-air-blowing orifice) of the hot air nozzle 4 is larger in area than the orifice (the suction orifice) of the suction nozzle.

Tube illustrated with dotted-twice-and-dashed lines in FIG. 3 connects the hot air nozzle 4 to the heater pump 44, and the suction nozzle 5 to the suction pump 45 independently.

At a center of the nozzle head 42, an opening is formed. In the solder mounting, the camera module 2 is positioned (inserted) to the opening. FIG. 4 is a view illustrating a state where the camera module structure 100 is positioned to the opening. The nozzle head 42 has the hot air nozzle 4 at an outer position with respect to the opening, and the suction nozzle 5 at an inner position with respect to the opening. In FIG. 4, dashed lines from the hot air nozzles 4 illustrate ducts of the hot air nozzles 4, and dotted-twice-and-dashed lines illustrate ducts of the suction nozzles 5. These ducts are formed on a back surface (a surface facing the printed circuit board 1) of the nozzle head 42.

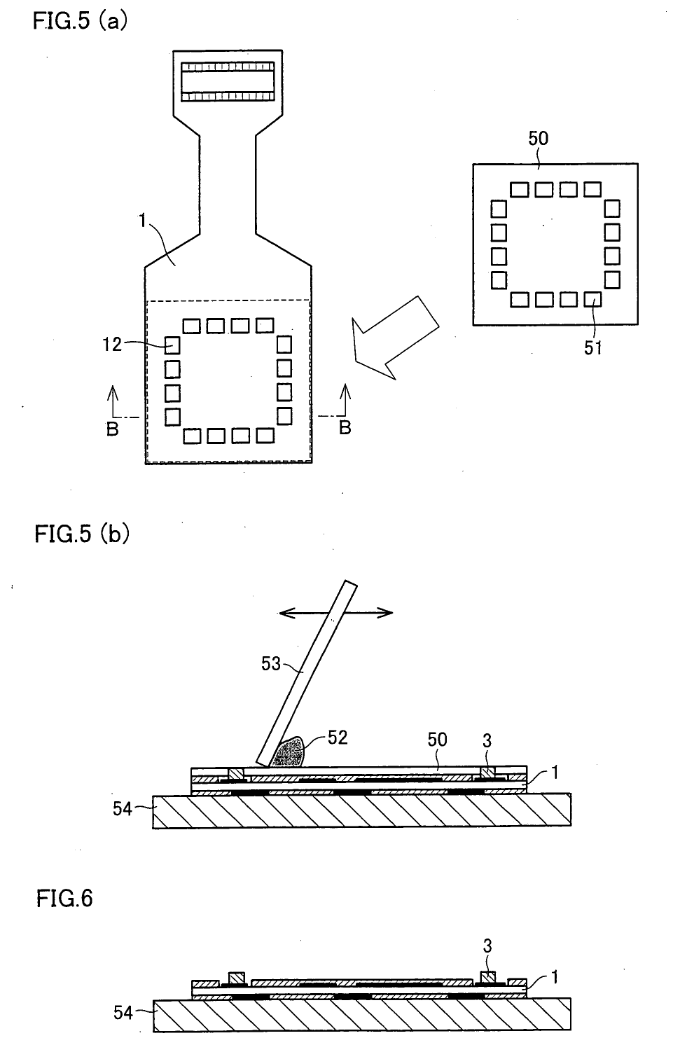

Next, the following explains a method employing the manufacture apparatus 40, for manufacturing the camera module structure 100. FIGS. 5(a), 5(b), and 6 to 11 are flow sheets of a solder mounting step in the method for manufacturing the camera module structure 100.

First, the solder connection portion (the solder pad) 3 is formed on the printed circuit board 1 where the terminal 12 is formed. FIGS. 5(a) and 5(b) are views illustrating a solder printing that is a processing prior to a soldering for a surface mounting, and FIG. 5(b) is a cross-sectional view taken along the line B-B in FIG. 5(a). The solder connection portion 3 is formed by a solder printing employing a solder mask 50 as illustrated in FIG. 5(a). The solder mask 50 has an opening 51 that corresponds to the terminal 12 of the printed circuit board 1. The opening 51 is relatively smaller in area than the terminal 12.

The solder mask 50 is fitted to the area, as illustrated with dashed lines in FIG. 5(a), where the solder connection portion 3 is to be formed, in such a manner that the openings 51 are positioned on the terminals 12 of the printed circuit board 1. At this point, the printed circuit board 1 is put on a stage 54, as illustrated in FIG. 5(b).

Next, the solder mask 50 is coated with solder paste (cream solder) 52 that is provided on the solder mask 50, in such a manner that a squeegee (a spatula) 52 is pressed and moved laterally against the solder mask 50. This successfully provides the solder paste to the opening 51. The solder mask 50 is removed after a certain period, so that the solder connection portion 3 is formed on the terminal 12 as illustrated in FIG. 6.

As such, the solder printing is carried out as a screen printing in which, on a connecting surface between the printed circuit board 1 and the camera module 2, the solder paste 52 is used as ink via the solder mask.

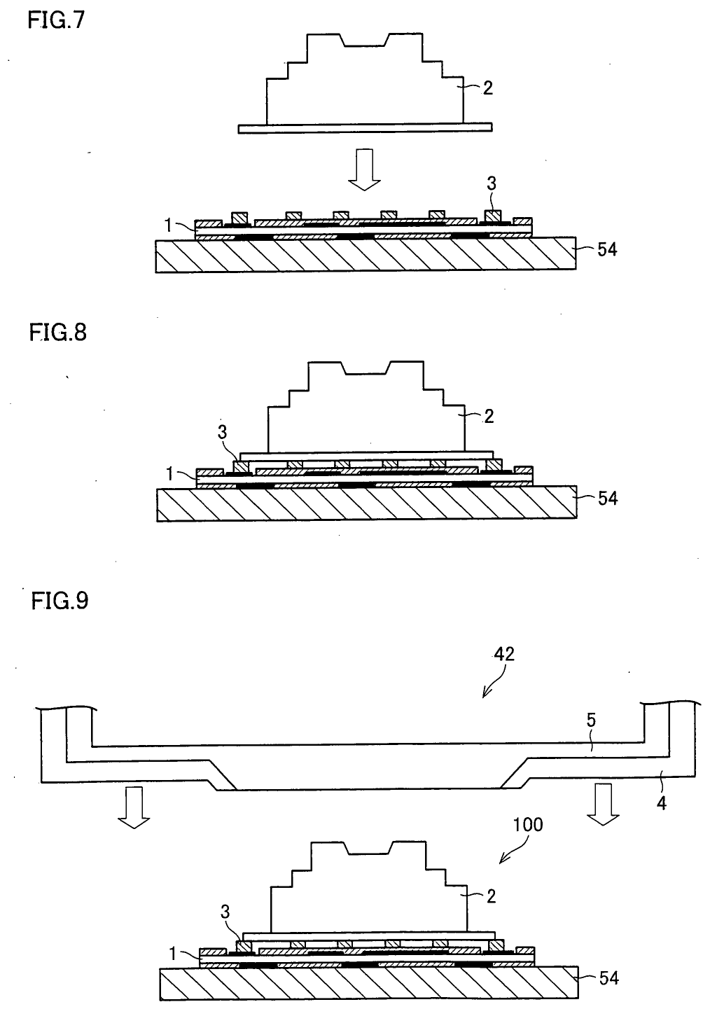

Next, as illustrated in FIGS. 7 and 8, the camera module 2 is positioned (mounted) on the printed circuit board 1 that is put on the stage 54. FIG. 7 is a view illustrating a state on mounting the camera module 2 on the printed circuit board 1, and FIG. 8 is a view illustrating a state after the camera module 2 is mounted (aligned) on the printed circuit board 1. The camera module 2 is positioned such that the terminal 21 (see FIG. 13) formed on the back surface of the camera module 2 substantially corresponds to the solder connection portion 3 formed on the terminal 12 of the printed circuit board 1. At this point, the camera module structure 100 has not been soldered yet. As will be described later, in the present embodiment, it is not necessary to perfectly align the positions of the terminal of the camera module 2, and the solder connection portion 3, because self-alignment of solder will be used.

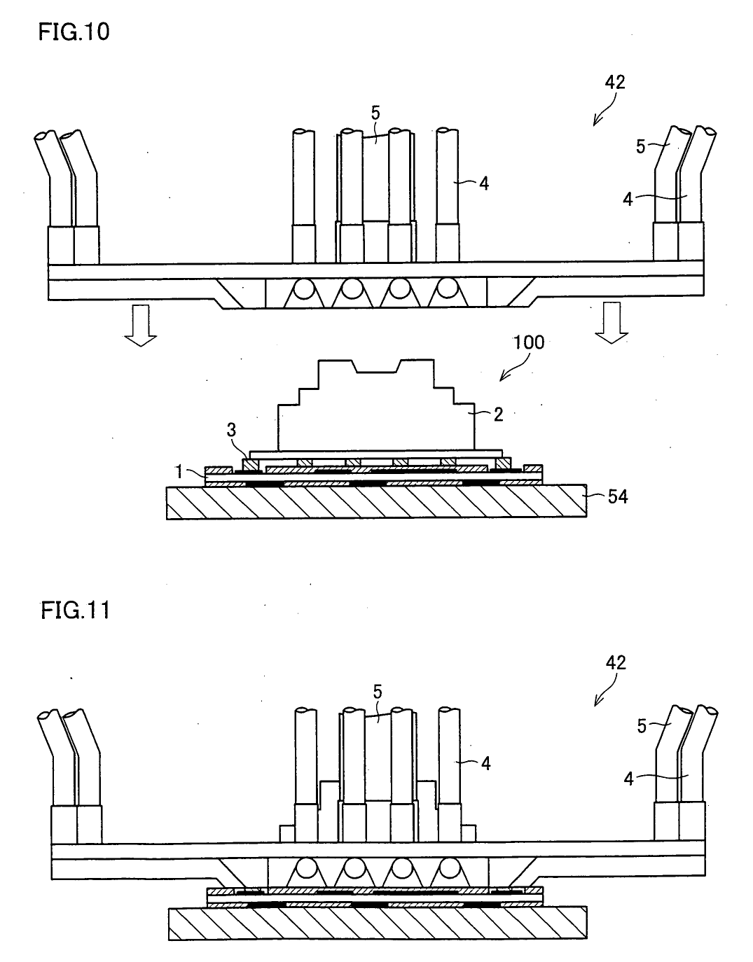

Next, as illustrated in FIGS. 9, 10, and 11, the camera module structure 100 that has not been soldered yet and the nozzle head 42 are moved relative to each other for preparation for melting solder. That is, the nozzle head 42 is moved from a primary position (see FIGS. 9 and 10) to a position (see FIG. 11) where the hot air nozzle 4 can blow the hot air to the solder connection portion 3.

Then, the hot air nozzle 4 blows the hot air to the solder connection portion 3, thereby melting solder at the solder connection portion 3. With the melted solder cooled, the camera module 2 is solder-mounted on the printed circuit board 1.

In this way, the soldering between the printed circuit board 1 and the camera module 2 is completed so that the camera module structure 100 is manufactured.

Here, a most significant feature of the present embodiment is that the suction nozzle 5 is positioned nearer from the camera module 2 than the position of the hot air nozzle 4 (a hot-air-blowing position), and suctions the hot air, while melting the solder (that is, at the same time as the blow of the hot air).

The following specifically explains this feature with reference to FIG. 1. FIG. 1 is a view illustrating a flow of atmosphere in the vicinity of the hot air nozzle 4 and the suction nozzle 5 in the solder mounting step. In order to melt the solder, the hot air nozzle 4 blows the hot air to the vicinity of the solder connection portion 3 (the solder connection portion 3, the printed circuit board 1, and the soldering portion (the terminal 21) of the camera module 2). However, even if arranged to be blown selectively to the solder connection portion 3, the hot air flows into regions outside the solder connection portion 3. Thereby, when the hot air flows toward the camera module 2 having the heat-vulnerable optical component, heat of the hot air damages the camera module 2.

Accordingly, the suction nozzle 5 should suction at least the hot air that flows to the camera module 2. This allows the hot air to blow mainly (selectively) to the solder connection portion 3. Therefore, it becomes possible to prevent the camera module 2 from being damaged by heat of the hot air. Thus, the camera module 2 having the heat-vulnerable optical component can be mounted on the printed circuit board 1 without being damaged by heat.

Further, the suction nozzle 5 preferably suctions not only the hot air that moves toward the camera module 2 but also the excess hot air that does not contribute to the melting of the solder. For example, the suction nozzle 5 preferably suctions atmosphere in the process room 41 in addition to the hot air described above. That is, it is preferable that the suction nozzle 5 positively suctions not only the hot air but also the atmosphere (open air) in the vicinity of the camera module 2. This ensures the prevention of the hot air from flowing to the camera module 2. Particularly, it is possible to prevent convection of heat (the excess hot air) toward an upper part of the camera module 2, which upper part has the heat-vulnerable optical component.

Furthermore, by intentionally suctioning the atmosphere in the process room 41, and the atmosphere (the open air) in the vicinity of the camera module 2, in addition to the hot air, it becomes possible to cool the solder down to a room temperature by the open air that is simultaneously suctioned with the hot air. That is, the melted solder can be efficiently cooled.

In the present embodiment, the angle of the end (an exhausting orifice) of the hot air nozzle 4 is variable, so that it is possible to arbitrarily set the angle of the end of the hot air nozzle 4. This makes it possible that, for the solder mounting, the setting of the angle of the hot air nozzle 4 is adjusted in accordance with a size or a position of the electronic component that is to be mounted on the printed circuit board 1.

In the present embodiment, with the end arranged to incline in an inward direction of the camera module 2, the hot air nozzle 4 blows the hot air. The end of the hot air nozzle 4 inclines in an inward direction of the solder mounting structure. This causes the hot air to blow to the solder connection portion 3 in an oblique direction from the opposite side of the camera module 2. Thereby, the camera module 2 does not obstruct the blow of the hot air from the hot air nozzle 4 to the solder connection portion 3.

In the present embodiment, the orifice (an hot-air-exhaust orifice) of the hot air nozzle 4 is larger in area than the orifice (the suction orifice) of the suction nozzle 5. Thus, it becomes easy to control the temperature by adjusting an exhaust amount of the hot air.

Further, in the present embodiment, the hot air nozzle 4 and the suction nozzle 5 are positioned close to each other, so that the suction nozzle can successfully suction the hot air from the hot air nozzle. Furthermore, in the present embodiment, the nozzle head 42 has an arrangement in which the hot air nozzle 4 and the suction nozzle 5 are formed integrally, so that it is possible to move the hot air nozzle 4 and the suction nozzle 5 at the same time.

Moreover, in the present embodiment, it is preferable to exhaust the hot air from all the hot air nozzles 4 of the nozzle head 42 at the same time. That is to say, it is preferable to melt the solder at each of the solder connection portions 3 at the same time. This makes it possible to align the positions of the printed circuit board 1 and the camera module 2 by the self-alignment. Accordingly, it becomes possible to align the positions of the printed circuit board 1 and the camera module 2 with high accuracy.

In the present embodiment, as illustrated in FIG. 13, a plurality of the terminals 12 is positioned on the printed circuit board 1. That is, there is also a plurality of the solder connection portions 3. The hot air nozzle 4 is provided to each of the terminals 12 independently. In other words, the hot air nozzle 4 is the same as the terminal 12 (the solder connection portions 3) in number. For this reason, the hot air nozzle 4 can blow the hot air to each of a plurality of the solder connection portions 3 (the terminals 12) independently. Therefore, it is possible to blow the hot air either exclusively to an arbitrary solder connection portion 3, or to all the solder connection portions 3 uniformly.

In the present embodiment, one suction nozzle 5 suctions the hot air from four hot air nozzles 4. The suction nozzle 5 is fewer than the hot air nozzle 4.

Meanwhile, in the present embodiment, a heating temperature and a heating period of the solder connection portion 3 may be set by taking into consideration: a melting temperature of the solder for use; an upper temperature limit (heat resistance) of the electronic component that is to be mounted on the printed circuit board 1; and the like. That is, they may be set to be, but not limited to, within a range in which the printed circuit board 1 and the camera module 2 cannot be damaged by heat.

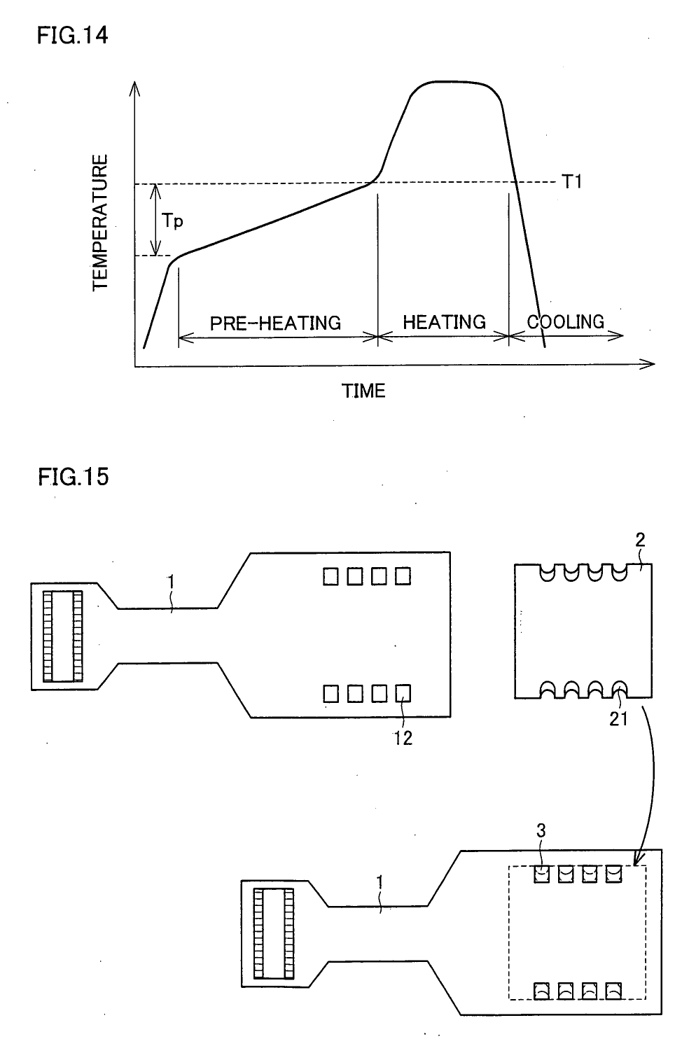

For example, the heating (a temperature of the hot air) with respect to the solder connection portion 3 by the hot air nozzle 4 may be carried out in accordance with a temperature profile of a solder melting as showed in FIG. 14. In the temperature profile of FIG. 14, the solder mounting step is preferably constituted by a pre-heating step, a heating step, and a cooling step. Specifically, the solder connection portion 3 is temporarily kept at a pre-heating temperature (Tp) that is lower than a solder melting temperature, so as to uniform temperature distribution of the solder connection portion 3 (the pre-heating step). Then, the solder connection portion 3 is heated to a temperature equal to or higher than the solder melting temperature (T1) (the heating step), after that, the solder that is heated to the temperature equal to or higher than the solder melting temperature is cooled ultimately (the cooling step).

For example, the solder is heated at the pre-heating temperature (Tp) of approximately 210° C. in the pre-heating step, and then, is heated up to the solder melting temperature of approximately 230° C., and kept at the temperature for approximately 2 to 10 seconds. After the heating, the melted solder is rapidly cooled down to the room temperature (approximately 25° C.). This prevents granulation of the melted solder, so that it is possible to successfully carry out the solder mounting.

Thus, by providing the pre-heating step and the heating step, the solder connection portion is heated to a temperature not over the solder melting temperature in the pre-heating step. This makes it possible to uniform the temperature distribution of the solder connection portion 3 in the pre-heating step in advance, and then, melt the solder in the heating step. Therefore, it becomes easy to melt all the solder connection portions 3 at the same time. That is, for a self-alignment effect, it is preferable to carry out these steps.

Further, with the cooling step after the heating, it is possible to prevent the granulation of the melted solder.

During the cooling step, the blow of the hot air from the hot air nozzle 4 may be stopped, for example. This enables atmosphere (the open air) in the vicinity of the camera module 2 to cool the solder melted in the heating step, since the hot air does not blow to the solder connection portion 3.

In the cooling step, the hot air nozzle 4 may blow cold air to the solder connection portion 3 after the heating, instead of blowing the hot air. In this case, the cold air, or a combination of the cold air and the atmosphere (the atmosphere (the open air) in the vicinity of the camera module 2) in the process room 41 can rapidly cool the melted solder. This can reduce a period of the solder mounting step, compared with the case of only stopping the blow of the hot air. Accordingly, it becomes possible to increase production efficiency.

The solder melting temperature of the solder connection portion 3 is preferably, but not limited to, in a range of 140° C. to 219° C., particularly 183° C. to 190° C., for example.

A sort of the solder employed for the solder connection portion 3 is preferably, but not limited to, lead-free solder in consideration of the environment. For example, Sn—Ag solder, Sn—Zn solder, Sn—Bi solder, Sn—In solder, or Sn—Ag—Cu solder may be used, but not limited to, as the lead-free solder. Further, a compositional ratio of each solder component is not particularly limited. Eutectic solder (containing a lead component) may be used, too.

The solder of the solder connection portion 3 may be solder containing flux. In other words, the solder may be solder paste (cream solder) including a flux agent or the like. This improves wettability and flowability of the solder, thereby resulting in a higher self-alignment effect. Even if flux spreads in the solder mounting step, the suction nozzle 5 can suction and collect the flux.

A sort of flux may be selected depending on components of electrodes that are formed on each electronic component (the camera module 2) and wiring board (the printed circuit board 1), and is not particularly limited. For example, corrosive flux (such as ZnCl₂—NH₄Cl mixed salt), slow flux (such as organic acid and its derivatives), non-corrosive flux (such as a mixture of pine resin (rosin) and isopropyl alcohol), soluble flux (such as rosin flux), or low-residue flux (such as rosin or resin flux whose solid content is equal to or lower than 5%, and whose activator is organic acid) may be used as the flux.

In the explanation described above, as illustrated in FIG. 13, the terminal 12 on the printed circuit board 1, and the solder connection portion 3 on the terminal 12 are positioned to a mounting region (the four lines of the quadrangle) of the camera module 2. However, the terminal 12 and the solder connection portion 3 are not limited to these positions, and may be arbitrarily determined. The nozzle head 42 (the hot air nozzle 4 and the suction nozzle 5) may be designed in accordance with the positions of the terminals 12 (the solder connection portion 3). For example, as illustrated in FIG. 15, the terminals 12 (the solder connection portions 3) may be formed to only two sides of a quadrangular mounting region of the camera module 2.

As described above, in the present embodiment, the suction nozzle 5 suctions the hot air that moves toward the camera module 2, so that even if the hot air flows off toward the camera module 2 by the blow of the hot air from the hot air nozzle 4, the flow-off hot air is successfully suctioned. As a result, it becomes possible to selectively heat the solder connection portion 3. Accordingly, the camera module 2 having the heat-vulnerable optical component can be mounted on the printed circuit board 1 without being damaged by heat in melting solder. Further, of the optical component of the camera module 2, it is possible to decrease deformation or a failure caused by a thermal shock and a stress. Furthermore, the self-alignment effect results in a decrease in misalignment between the printed circuit board 1 and the camera module 2, and easiness in alignment of them, thereby decreasing a mounting defect.

### EMBODIMENT 2

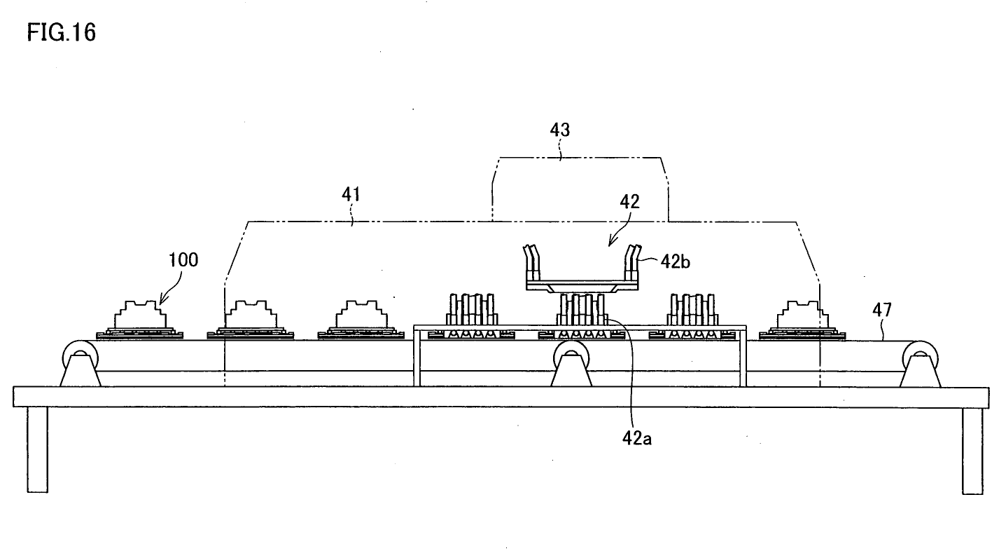

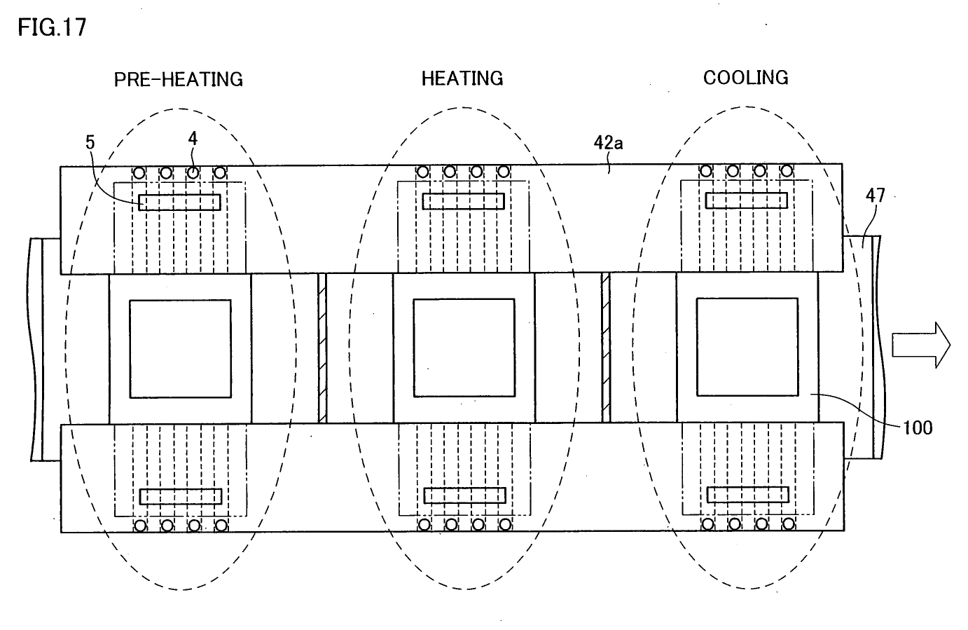

Next, the following explains another embodiment of the present invention with reference to FIGS. 16 to 20. In the present embodiment, the differences between the embodiment 1 and the present embodiment are mainly explained, and explanations regarding the same parts are omitted. The following explains the present embodiment.

In the embodiment 1, as illustrated in FIG. 2, the camera module structure 100 is carried into the process room 41 and solder-mounted one by one.

In the present embodiment, explained is an arrangement in which a plurality of the camera module structures 100 is carried into the process room 41, and the solder mounting step is carried out.

FIG. 16 is a view illustrating a vicinity of the process room 41 of a manufacturing apparatus of the present embodiment. Further, FIG. 17 is a view illustrating a nozzle head 42a positioned in the process room 41 of the manufacturing apparatus of FIG. 16.

The manufacturing apparatus (see FIG. 16) of the present embodiment and the manufacturing apparatus (see FIG. 2) of the embodiment 1 are the same in the basic arrangement. The manufacturing apparatus of the present embodiment also employs the nozzle head 42 in which the hot air nozzle 4 and the suction nozzle 5 are formed integrally. The hot air nozzle 4 is connected with the heater pump (not illustrated), and realizes the temperature profile of FIG. 14, while the hot air nozzle 4 can adjust the flow amount of the hot air. Further, the hot air nozzle 4 heats inactive gas (nitrogen), and exhausts it as the hot air, so as to prevent oxidation of solder.

However, the present embodiment differs in an arrangement of the nozzle head 42. In the present embodiment, for the pre-heating step, the heating step, and the cooling step, two nozzle heads 42a are provided respectively. The two nozzle heads 42a faces each other, and are parallel to a conveyance direction of the camera module structure 100. The two nozzle heads 42a are positioned apart so that the camera module 2 is carried therebetween. The two nozzle heads 42a are fixed in the process room 41, and do not move up and down relative to each of the camera module structures 100. The camera module 100 is carried in a lateral direction (a direction pointed by an arrow in FIG. 17) between the two nozzle heads 42a.

Further, in the present embodiment, for the heating step, other two nozzle heads 42b are provided perpendicular to the two nozzle heads 42a. A total of four nozzle heads 42a and 42b are used in the heating step. These four nozzle heads 42a and 42b are arranged to blow and suction the hot air from the same direction as the nozzle head 42 (see FIG. 3) of the embodiment 1.

In the present embodiment, nozzle heads 42a and 42b are provided for each step, thereby making it possible to carry out the solder mounting of a plurality of the camera module structures 100 one after another.

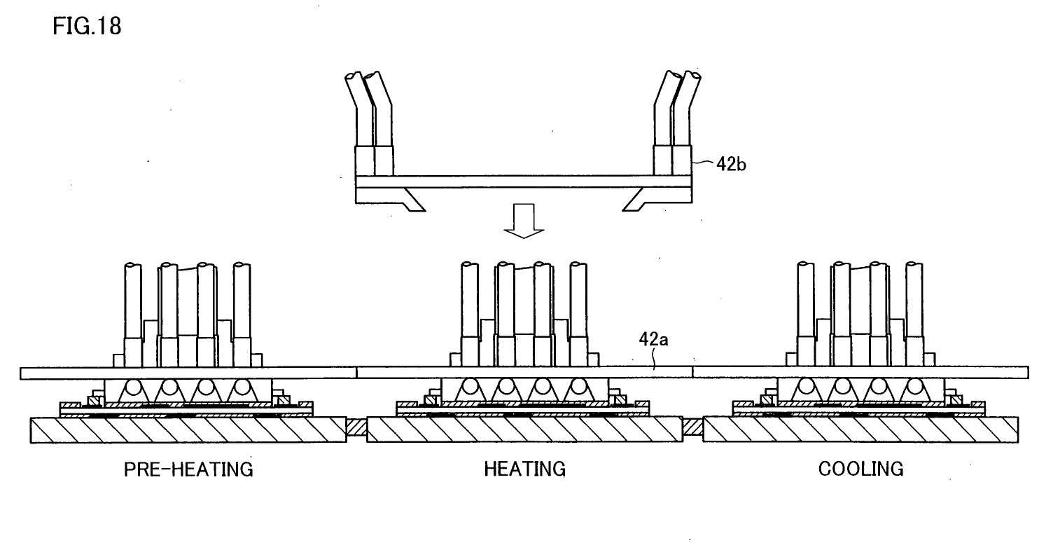

Here, the following explains the solder mounting step employing the manufacturing apparatus of the present embodiment with reference to FIGS. 16 to 20. FIGS. 18 to 20 are views illustrating the solder mounting step. Here, as illustrated in FIG. 13, the following explains a soldering with respect to the solder connection portions 3 formed on the terminals 12 that are formed at four sides of the quadrangular mounting region of the camera module 2.

As illustrated in FIG. 16, the camera module structure 100 is carried inside the process room 41, from left to right in FIG. 16. When the camera module structure 100 reaches a region of the nozzle head 42 for each step as illustrated in FIG. 17, the pre-heating step, the heating step, and the cooling step are carried out in turn. The camera module structure 100 is slid to the next step on completion of each step (a pipeline processing).

In the pre-heating step, the temperature distribution of the solder connection portion 3 has only to be substantially uniform. For this reason, as illustrated in FIG. 17, even with such a nozzle head 42a that the hot air nozzles 4 are positioned on facing two sides of the camera module 2, and the other two sides are merely open, a desired temperature distribution of all the solder connection portions 3 can be realized. After through the pre-heating step, the camera module structure is carried to a position for the heating step on a sliding movement of a conveyor belt 47.

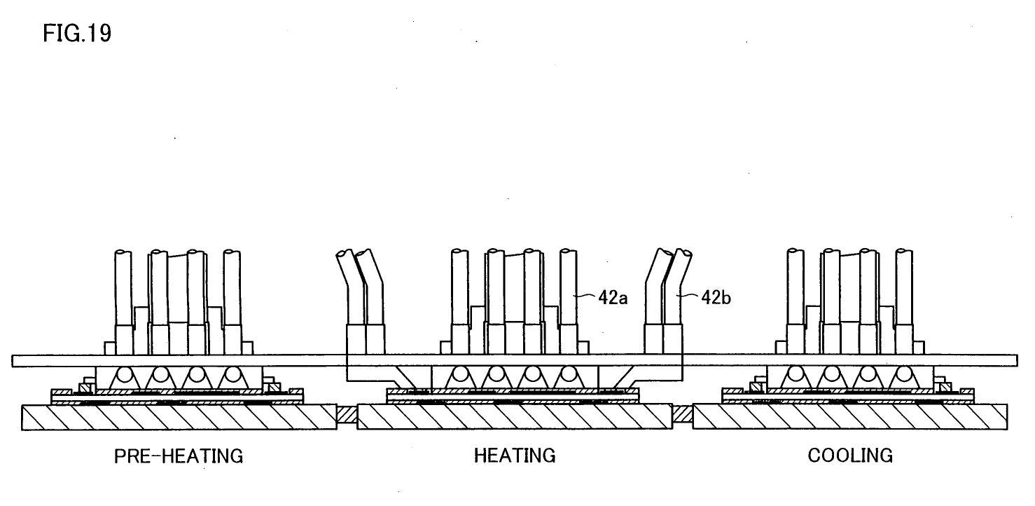

The heating step is carried out in such an arrangement that the nozzle head 42b moves down from the primary position as illustrated in FIG. 18, and stops at the same height as the nozzle head 42a (a height of the soldering portion) as illustrated in FIG. 19. The elevating machine 43 moves the nozzle head 42b up and down.

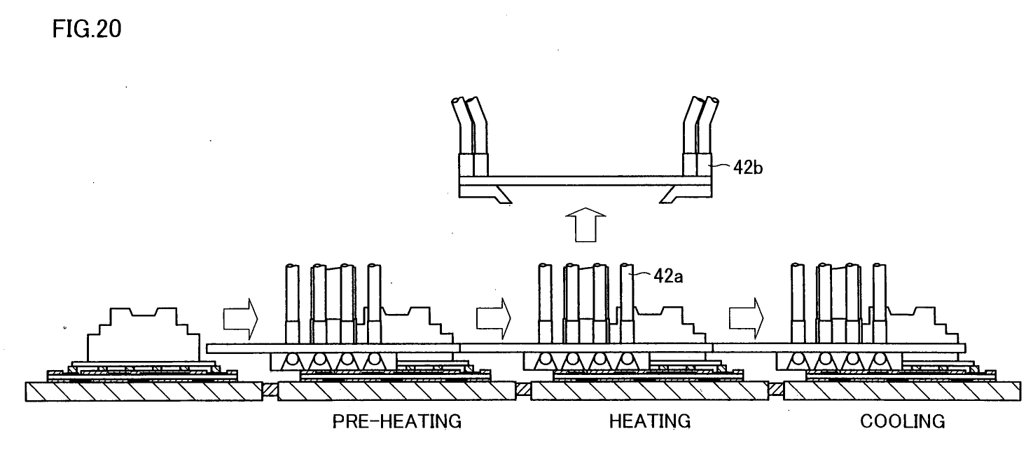

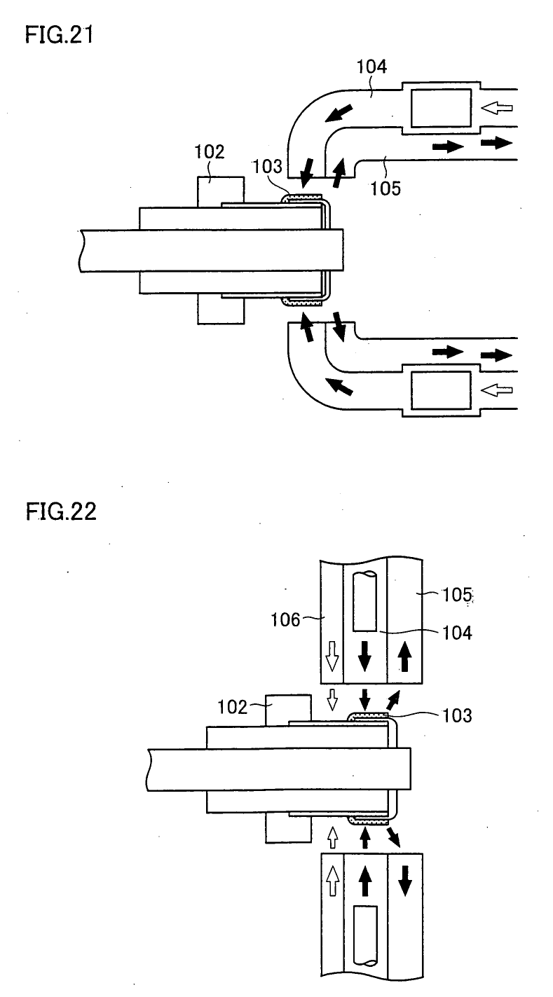

When the heating step finishes, the nozzle head 42b moves up to the primary position as illustrated in FIG. 20, and simultaneously, the camera module structure 100 is slid to a position for the cooling step by the conveyor belt 47.

During the cooling step, the blow of the hot air from the nozzle head 42a is stopped as in the pre-heating step, or the hot air nozzle 4 of the nozzle head 42a blows the cold air.

As such, only in the heating step the nozzle heads 42a and 42b are used to blow the hot air, so that the camera module structure 100 is carried smoothly. This improves the production efficiency. The nozzle heads 42a and 42b may be used in each step.

Thus, according to the present embodiment, the nozzle head 42 is provided respectively for the pre-heating step, the heating step, and the cooling step, so that it becomes possible to carry out each of the steps one after another. For this reason, compared with the arrangement of the embodiment 1, a plurality of the camera module structures 100 is manufactured continuously, thereby resulting in an improvement in the production efficiency.

The camera module 2 explained in each embodiment is constituted by; optical components such as a lens and an infrared cut filter; and a drive section for functions such as zoom and autofocus. This drive section includes a magnet.

Here, the soldering employing a reflow apparatus is a technique for carrying out a soldering by melting solder in a reflow furnace that is heated to approximately the solder melting temperature (approximately 230° C.). The temperature inside the reflow furnace rises over 200° C.

However, the upper temperature limit (the temperature within which optical functions and characteristics can be maintained) of the optical components of the camera module is 80° C., which is lower than the temperature inside the reflow furnace. Further, there is a possibility that the magnet that is used in the drive section of the camera module is demagnetized under a high temperature condition.

Generally, the Curie Temperature is a temperature at which a magnet completely loses magnetic forces, and is 450° C. for a ferrite magnet, and 850° C. for an alnico magnet. The Curie Temperature is the temperature at which the magnet completely loses magnetic forces, but even at temperatures lower than the Curie Temperature, the magnetic forces tends to, not completely lose the magnetic forces though, become weak with the temperature getting higher. Particularly, the ferrite magnet easily loses the magnetic forces along with the temperature getting higher. For example, when the magnetic forces of the ferrite magnet are 100% at 20° C., the magnetic forces decrease to approximately 90% at 50° C., approximately 80% at 100° C., and approximately 50% at 200° C. However, under approximately 200° C., the magnetic forces generally can rally back to the primary state after being heated.

According to the present invention, it is possible to prevent the hot air from flowing off to the camera module 2, so that even if the camera module 2 includes a magnet, thermal demagnetization can be prevented.

Further, in each embodiment, the camera module 2 is used as an example of the electronic component that is mounted on the printed circuit board 1, but the electronic component is not limited to the camera module 2. For example, a semiconductor chip, an IC chip, or the like, more preferably a heat-vulnerable optical element (an optical component), may be used as the electronic component. As such an optical element, a lens module having a set of: a lens; an infrared cut filter; and a sensor device may be used, for example.

The present invention is suitable for mounting and soldering a camera module (an image device) for a mobile phone or a digital still camera. The camera module includes a heat-vulnerable optical component (such as a color filter). According to the present invention, the camera module can be mounted on a board without the heat-vulnerable optical component being damaged by heat. Further, it is possible to align the board and the optical component with high accuracy by self-alignment of melted solder.

As described above, with a method and an apparatus, according to the present invention, for manufacturing a solder mounting structure, hot air that moves toward an electronic component is suctioned from a position nearer from the electronic component than a hot air blowing position, while the hot air melts solder. This enables the electronic component to be mounted on a wiring board without being damaged by heat. Accordingly, it becomes possible to manufacture the solder mounting structure in which a heat-vulnerable electronic component is mounted on the wiring board without being damaged by heat.

In the method according to the present invention, for manufacturing the solder mounting structure, it is preferable to blow the hot air to a solder connection portion in an oblique direction from an opposite side of the electronic component in a solder mounting step.

With the method, the hot air blows to the solder connection portion in an oblique direction from the opposite side of the electronic component. This can prevent the electronic component from obstructing a blow of the hot air to the solder connection portion.

In the method according to the present invention, for manufacturing the solder mounting structure, the step of mounting preferably includes pre-heating solder at the solder connection portion to a temperature not over a melting temperature, and heating the pre-heated solder to a temperature equal to or higher than the melting temperature.

With the method, the solder at the solder connection portion is pre-heated to a temperature not over the melting temperature in the pre-heating step, before being melted in the heating step. This makes it possible that a temperature distribution of the solder connection portion is uniformed in the pre-heating step in advance, before the solder is melted in the heating step.

The method according to the present invention, for manufacturing the solder mounting structure, preferably includes cooling the solder heated to a temperature equal to or higher than the melting temperature in the heating step.

With the method, after the heating step, the heated solder is cooled in the cooling step, so that it is possible to prevent granulation of the melted solder, and successfully carry out the soldering.

In the method according to the present invention, for manufacturing the solder mounting structure, it is preferable to stop the blow of the hot air during the cooling step.

With the method, the blow of the hot air is stopped, so that it is possible to cool the melted solder by atmosphere (open air) in the vicinity of the solder mounting structure.

In the method according to the present invention, for manufacturing the solder mounting structure, in the cooling step, it is preferable to blow cold air to the solder connection portion that is heated in the heating step.

With the method, in the cooling step, the blow of the hot air is stopped, and replaced by a blow of the cold air, so that it is possible to rapidly cool the melted solder by the cold air or a combination of the cold air and the atmosphere (open air) in the vicinity of the solder mounting structure. This can reduce a period of the solder mounting step. Thus, production efficiency improves.

In the method according to the present invention, for manufacturing the solder mounting structure, it is preferable to continuously carry out a series of: the pre-heating step and the heating step; the heating step and the cooling step; or the pre-heating step, the heating step, and the cooling step.

With the method, it is possible to carry out the pre-heating step, the heating step, and the cooling step one after another. This can improve the production efficiency because a plurality of the solder mounting structure is manufactured continuously.

In the method according to the present invention, for manufacturing the solder mounting structure, it is preferable to melt the solder at each solder connection portion at the same time.

With the method, all the solder is melted at the same time, so that it is possible to align and mount the electronic component on the wiring board with high accuracy by a self-alignment effect of the melted solder.

In the method according to the present invention, for manufacturing the solder mounting structure, the hot air may be a first inactive gas that is heated. Further, in the method according to the present invention, for manufacturing the solder mounting structure, the step of mounting may be carried out under an atmosphere of a second inactive gas. This can prevent the hot air from oxidizing the solder. It is preferable to use nitrogen as the first inactive gas and the second inactive gas in consideration of availability, safety, and costs.

In the method according to the present invention, for manufacturing the solder mounting structure, the solder connection portion may be made of lead-free solder.

With the method, the solder connection portion does not include lead, so that it is possible to have an environmentally-friendly manufacturing method.

In an apparatus according to the present invention, for manufacturing a solder mounting structure, it is preferable that an angle of an end of a hot air nozzle is variable.

With the arrangement, it is possible to arbitrarily set the angle of the end of the hot air nozzle. Accordingly, it is possible that, for the solder mounting, the setting of the angle of the hot air nozzle is adjusted in accordance with a size or a position on a substrate, of an electronic component.

In the apparatus according to the present invention, for manufacturing the solder mounting structure, the end of the hot air nozzle may be inclined in an inward direction of the solder mounting structure.

With the arrangement, the end of the hot air nozzle is inclined in an inward direction of the solder mounting structure. This causes the hot air nozzle to blow the hot air to the solder connection portion in an oblique direction from an opposite side of the electronic component. For this reason, it becomes possible to prevent the electronic component from obstructing a blow of the hot air from the hot air nozzle to the solder connection portion.

In the apparatus according to the present invention, for manufacturing the solder mounting structure, an orifice of the hot air nozzle may be larger in area than an orifice of the suction nozzle.

With the arrangement, the orifice of the hot air nozzle is larger in area than the orifice of the suction nozzle. This makes it easy to adjust an exhaust amount of the hot air. Thus, it becomes possible to rapidly raise a temperature in a heating step by exhausting a large amount of the hot air. Further, it becomes possible to rapidly lower the temperature at the end of the heating by reducing (or stopping) a large amount exhaust of the hot air. That is, it becomes easy to control the temperature by adjusting the exhaust amount of the hot air.

In the apparatus according to the present invention, for manufacturing the solder mounting structure, it is preferable to provide the hot air nozzle and the suction nozzle close to each other.

With the arrangement, the hot air nozzle and the suction nozzle are close to each other, so that it is possible for the suction nozzle to successfully suction the hot air blown from the hot air nozzle.

In the apparatus according to the present invention, for manufacturing the solder mounting structure, the hot air nozzle and the suction nozzle may be formed integrally.

With the arrangement, the hot air nozzle and the suction nozzle are formed integrally, so that it is possible to move the hot air nozzle and the suction nozzle at the same time. Note that the integral structure means, for example, a structure in which the hot air nozzle and the suction nozzle are provided on a single substrate, or a structure in which a single nozzle has functions of both the hot air nozzle and the suction nozzle.

In the apparatus according to the present invention, for manufacturing the solder mounting structure, a plurality of solder connection portions may be formed on a wiring board, and the hot air nozzle may be provided to correspond to each of the solder connection portions independently.

With the arrangement, the number of the hot air nozzles is the same as that of the solder connection portions, so that it is possible to blow the hot air to each of the solder connection portions. This makes it possible to blow the hot air to an arbitrary solder connection portion, and also to all the solder connection portions uniformly. This arrangement is particularly suitable for a self-alignment effect.

In the apparatus according to the present invention, for manufacturing the solder mounting structure, it is preferable that the suction nozzle suctions the hot air from a plurality of the hot air nozzles.

With the arrangement, the suction nozzle suctions the hot air exhausted from a plurality of the hot air nozzles, so that it is possible to have fewer suction nozzles than the hot air nozzles. In other words, this arrangement is an arrangement in which a plurality of the suction nozzles is formed integrally.

In the apparatus according to the present invention, for manufacturing the solder mounting structure, it is preferable that the hot air nozzle heats the solder at the solder connection portion to a temperature not over a melting temperature in pre-heating the solder connection portion, and then, the pre-heated solder is heated to a temperature equal to or higher than the melting temperature in heating the solder connection portion.

With the arrangement, the hot air nozzle heats the solder connection portion to a temperature not over the melting temperature in the pre-heating, and then, heats the solder connection portion to a temperature equal to or higher than the melting temperature in the heating. This makes it possible that a temperature distribution of the solder connection portion is uniformed in the pre-heating in advance before the solder is melted in the heating.

In the apparatus according to the present invention, for manufacturing the solder mounting structure, after the heating, the hot air nozzle preferably stops blowing the hot air to the solder connection portion.

With the arrangement, after the heating, the hot air nozzle does not blow the hot air to the solder connection portion. This can cool the melted solder by atmosphere (open air) in the vicinity of the solder mounting structure.

In the apparatus according to the present invention, for manufacturing the solder mounting structure, after the heating, the hot air nozzle preferably blows cold air to the solder connection portion.

With the arrangement, after the heating, the hot air nozzle blows the cold air to the solder connection portion. Thus, it is possible to cool the melted solder by the cold air or a combination of the cold air and the atmosphere (open air) in the vicinity of the solder mounting structure. This can reduce a period of the solder mounting step. Accordingly, production efficiency improves.

In the apparatus according to the present invention, for manufacturing the solder mounting structure, the hot air nozzle preferably blows the hot air to each solder connection portion at the same time.

With the arrangement, the hot air exhausted from the hot air nozzle melts all the solder at the same time. Thus, it is possible to align and mount the electronic component on the wiring board with high accuracy by a self-alignment effect.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to the present invention, an electronic component can be mounted on a wiring board without being damaged by heat in melting solder. Therefore, the present invention is applicable to any kinds of a solder mounting, and an electronics industry. For example, the present invention is particularly useful for soldering for connecting, with a wiring board, a heat-vulnerable component such as a camera module in which a lens for a digital still camera, a mobile phone, or the like, and a solid-state image sensing device are formed integrally. Further, the present invention is also applicable to the soldering of an optical system (such as a CCD), a biosensor (a sensing device), a semiconductor (a semiconductor element of a mold), and the like.

1. A method for manufacturing a solder mounting structure, comprising:
mounting an electronic component on a wiring board via a solder connection portion, wherein:
in the step of mounting, a blow of hot air melts solder at the solder connection portion while the hot air moving toward the electronic component is suctioned from a position nearer from the electronic component than a hot air blowing position.

2. A method for manufacturing a solder mounting structure, comprising:
mounting an electronic component on a wiring board via a solder connection portion, wherein:
in the step of mounting, a blow of hot air melts solder at the solder connection, while the hot air moving toward the electronic component, and atmosphere in a vicinity of the electronic component are suctioned together from a position nearer from the electronic component than a hot air blowing position.

3. The method according to claim 1, for manufacturing the solder mounting structure, wherein:
in the step of mounting, the hot air is blown to the solder connection portion in an oblique direction from an opposite position of the electronic component.

4. The method according to claim 1, for manufacturing the solder mounting structure,
the step of mounting comprising:
pre-heating the solder at the solder connection portion to a temperature not over a melting temperature; and
heating the pre-heated solder to a temperature equal to or higher than the melting temperature.

5. The method according to claim 4, for manufacturing the solder mounting structure, further comprising:
cooling the solder heated to a temperature equal to or higher than the melting temperature in the heating step.

6. The method according to claim 5, for manufacturing the solder mounting structure, wherein:
during the step of cooling, the blow of the hot air is stopped.

7. The method according to claim 6, for manufacturing the solder mounting structure, wherein:
during the step of cooling, cold air is blown to the solder connection portion heated in the heating step.

8. The method according to claim 4, for manufacturing the solder mounting structure, wherein:
a series of: the pre-heating step and the heating step; the heating step and the cooling step; or the pre-heating step, the heating step, and the cooling step is carried out continuously.

9. The method according to claim 1, for manufacturing the solder mounting structure, wherein:
the solder at each solder connection portion is melted at the same time.

10. The method according to claim 1, for manufacturing the solder mounting structure, wherein:
the hot air is a first inactive gas that is heated.

11. The method according to claim 1, for manufacturing the solder mounting structure, wherein:
the step of mounting is carried out under an atmosphere of a second inactive gas.

12. The method according to claim 10, for manufacturing the solder mounting structure, wherein:
the first inactive gas is nitrogen gas.

13. The method according to claim 1, for manufacturing the solder mounting structure, wherein:
the solder connection portion is made of lead-free solder.

14. An apparatus for manufacturing a solder mounting structure in which an electronic component is mounted on a wiring board via a solder connection portion, comprising:
a hot air nozzle configured to blow hot air to the solder connection portion; and
a suction nozzle configured to suction the hot air,
the hot air nozzle melting solder at the solder connection portion by blowing the hot air to the solder connection portion, while the suction nozzle suctions the hot air moving toward the electronic component, from a position nearer from the electronic component than a hot air blowing position.

15. An apparatus for manufacturing a solder mounting structure in which an electronic component is mounted on a wiring board via a solder connection portion, comprising:
a hot air nozzle configured to blow hot air to the solder connection portion; and
a suction nozzle configured to suction the hot air,
the hot air nozzle melting solder at the solder connection portion by blowing the hot air to the solder connection portion, while the suction nozzle suctions the hot air moving toward the electronic component, and atmosphere in a vicinity of the electronic component concomitantly, from a position nearer from the electronic component than a hot air blowing position.

16. The apparatus according to claim 14, for manufacturing the solder mounting structure, wherein:
an angle of an end of the hot air nozzle is variable.

17. The apparatus according to claim 14, for manufacturing the solder mounting structure, wherein:
the end of the hot air nozzle inclines in an inward direction of the solder mounting structure.

18. The apparatus according to claim 14, for manufacturing the solder mounting structure, wherein:
an orifice of the hot air nozzle is larger in area than an orifice of the suction nozzle.

19. The apparatus according to claim 14, for manufacturing the solder mounting structure, wherein:
the hot air nozzle and the suction nozzle are provided close to each other.

20. The apparatus according to claim 14, for manufacturing the solder mounting structure, wherein:
the hot air nozzle and the suction nozzle are formed integrally.

21. The apparatus according to claim 14, for manufacturing the solder mounting structure, wherein:
a plurality of solder connection portions are formed on the wiring board, and a plurality of the hot air nozzles are provided to correspond to each of the solder connection portions independently.

22. The apparatus according to claim 14, for manufacturing the solder mounting structure, wherein:
the suction nozzle is configured to suction the hot air from a plurality of the hot air nozzles.

23. The apparatus according to claim 14, for manufacturing the solder mounting structure, wherein:
the hot air nozzle pre-heats the solder at the solder connection portion to a temperature not over a melting temperature, and heats the pre-heated solder at the solder connection portion to a temperature equal to or higher than the melting temperature in a heating step.

24. The apparatus according to claim 14, for manufacturing the solder mounting structure, wherein:
the hot air nozzle stops blowing the hot air to the solder connection portion heated in the heating.

25. The apparatus according to claim 14, for manufacturing the solder mounting structure, wherein:
the hot air nozzle blows cold air to the solder connection portion heated in the heating.

26. The apparatus according to claim 14, for manufacturing the solder mounting structure, wherein:
the hot air nozzle blows the hot air to each solder connection portion at the same time.

27. The method according to claim 11, for manufacturing the solder mounting structure, wherein:
the second inactive gas is nitrogen gas.
